(19) United States
(12) Patent Application Publication
(10) Pub. No.: US 2026/0269356 A1
(43) Pub. Date: Sep. 10, 2026

(54) ADAPTIVE THERMAL CONDITIONING FOR RECHARAGEABLE ENERGY STORAGE SYSTEMS

(71) Applicant: GM Global Technology Operations LLC, Detroit, MI (US)

(72) Inventors: Shobhit Gupta, Sterling Heights, MI (US); Chunhao J. Lee, Troy, MI (US); Jun-mo Kang, Ann Arbor, MI (US); Yongjie Zhu, Troy, MI (US)

(73) Assignee: GM Global Technology Operations LLC, Detroit, MI (US)

(21) Appl. No.: 19/071,072

(22) Filed: Mar. 5, 2025

(51) Int. Cl. H01M 10/633; H01M 10/44; H01M 10/48; H01M 10/613; H01M 10/625; H01M 10/635

(52) U.S. Cl. CPC H01M 10/633; H01M 10/443; H01M 10/486; H01M 10/613; H01M 10/625; H01M 10/635

(57) ABSTRACT

A method for controlling chilling of a coolant for cooling a rechargeable energy storage system (RESS) during charging of the RESS. The method includes obtaining a first value representative of an ambient temperature and obtaining a second value representative of a relative humidity. The method also includes determining an estimated dew point based on the first value and the second value and controlling a coolant chiller to maintain a temperature of the coolant to be greater than the estimated dew point during charging of the RESS.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

A rechargeable energy storage system (RESS) for a vehicle is an advanced technology designed to store electrical energy that can be used to power the vehicle's electric motor(s) or other components of the vehicle. The RESS typically includes a plurality of high-capacity batteries, battery cells, or supercapacitors, which are capable of being recharged, for example, by plugging the vehicle into an electrical outlet, using regenerative braking, or using solar panels. The RESS provides a sustainable and efficient alternative to traditional internal combustion engines by reducing reliance on fossil fuels and lowering emissions. The RESS ensures that the vehicle has a reliable source of power, enabling longer driving ranges and improved performance while contributing to environmental conservation.

The present disclosure relates generally to adaptive thermal conditioning for rechargeable energy storage systems.

### SUMMARY

An aspect of the disclosure provides a vehicle including a battery pack, a coolant chiller, data processing hardware, and memory hardware. The battery pack includes a plurality of battery cells and a plurality of passageways defined between the battery cells, wherein the plurality of passageways are configured to allow a coolant to flow through the plurality of passageways to cool the plurality of battery cells. The coolant chiller is configured to chill the coolant for cooling the plurality of battery cells during charging of the battery pack. The memory hardware is in communication with the data processing hardware and stores instructions that, when executed by the data processing hardware, cause the data processing hardware to perform operations. The operations include obtaining a first value representative of an ambient temperature, obtaining a second value representative of a relative humidity, determining an estimated dew point based on the first value and the second value, and controlling the coolant chiller to maintain a temperature of the coolant to be greater than the estimated dew point.

Implementations of the disclosure may include one or more of the following optional features. In some implementations, the operations also include controlling a rate of charging of the battery pack based on the temperature of the coolant. In some examples, the vehicle also includes a temperature sensor configured to measure the first value representative of the ambient temperature, and a hygrometer configured to measure the second value representative of the relative humidity. The vehicle may include a windshield including the hygrometer.

In some examples, the first value represents at least one of a measured ambient temperature or a forecasted ambient temperature, obtaining the first value representative of the ambient temperature includes obtaining the first value from a weather service, the second value represents at least one of a measured relative humidity or a forecasted relative humidity, and obtaining the second value representative of the relative humidity includes obtaining the second value from the weather service. In some implementations, the operations also include obtaining a first plurality of values representative of respective ambient temperatures over time, obtaining a second plurality of values representative of respective relative humidities over time, determining, based on the first plurality of values and the second plurality of values, a plurality of estimated dew points, and controlling the coolant chiller over time to maintain temperatures of the coolant to be greater the plurality of estimated dew points.

In some implementations, determining the estimated dew point includes using a calibrated model to determine, based on the first value and the second value, the estimated dew point, wherein parameters of the calibrated model are calibrated based on a psychometric chart representing physical and thermal properties of moist air. Determining the estimated dew point may include compensating for an uncertainty in the second value.

Another aspect of the disclosure provides a method for controlling chilling of a coolant for cooling a rechargeable energy storage system (RESS) during charging of the RESS. The method includes obtaining a first value representative of an ambient temperature, obtaining a second value representative of a relative humidity, determining an estimated dew point based on the first value and the second value, and controlling a coolant chiller to maintain a temperature of the coolant to be greater than the estimated dew point during charging of the RESS.

Implementations of the disclosure may include one or more of the following optional features. In some implementations, controlling a rate of charging of the RESS is based on the temperature of the coolant. In some examples, obtaining the first value includes obtaining the first value from a temperature sensor associated with the RESS, and obtaining the second value includes obtaining the second value from a hygrometer associated with the RESS. In some examples, the first value represents at least one of a measured ambient temperature or a forecasted ambient temperature, obtaining the first value representative of the ambient temperature includes obtaining the first value from a weather service, the second value represents at least one of a measured relative humidity or a forecasted relative humidity, and obtaining the second value representative of the relative humidity includes obtaining the second value from the weather service.

In some examples, determining the estimated dew point includes using a calibrated model to determine, based on the first value and the second value, the estimated dew point, wherein parameters of the calibrated model are calibrated based on a psychometric chart representing physical and thermal properties of moist air. Determining the estimated dew point further may include compensating for an uncertainty in the second value.

Yet another aspect of the disclosure provides a system for controlling chilling of a coolant for cooling a rechargeable energy storage system (RESS) during charging of the RESS. The system includes data processing hardware, and memory hardware in communication with the data processing hardware and storing instructions that, when executed by the data processing hardware, cause the data processing hardware to perform operations. The operations include obtaining a first value representative of an ambient temperature. obtaining a second value representative of a relative humidity, determining an estimated dew point based on the first value and the second value, and controlling a coolant chiller to maintain a temperature of the coolant to be greater than the estimated dew point during charging of the RESS.

Implementations of the disclosure may include one or more of the following optional features. In some implementations, the operations also include controlling a rate of charging of the RESS based on the temperature of the coolant. In some examples, obtaining the first value includes obtaining the first value from a temperature sensor associated with the RESS, and obtaining the second value includes obtaining the second value from a hygrometer associated with the RESS. In some implementations, the first value represents at least one of a measured ambient temperature or a forecasted ambient temperature, obtaining the first value representative of the ambient temperature includes obtaining the first value from a weather service, the second value represents at least one of a measured relative humidity or a forecasted relative humidity, and obtaining the second value representative of the relative humidity includes obtaining the second value from the weather service.

In some examples, determining the estimated dew point includes using a calibrated model to determine, based on the first value and the second value, the estimated dew point, wherein parameters of the calibrated model are calibrated based on a psychometric chart representing physical and thermal properties of moist air. Determining the estimated dew point may include compensating for an uncertainty in the second value.

### BRIEF DESCRIPTION OF THE DRAWINGS

The drawings described herein are for illustrative purposes only of selected configurations and are not intended to limit the scope of the present disclosure.

FIG. 1 is a side view of an example vehicle including a rechargeable energy storage system (RESS) in accordance with the principles of the present disclosure.

FIG. 2 is a schematic view of the RESS of FIG. 1.

FIG. 3 is a flow chart of an example arrangement of operations for a method of adaptive thermal conditioning for the RESS of FIG. 1.

FIG. 4 is a schematic view of an example computing device that may be used to implement the systems and methods described herein.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A rechargeable energy storage system (RESS) for a vehicle is an advanced technology designed to store electrical energy that can be used to power the vehicle's electric motor(s) or other components of the vehicle. The RESS typically includes a plurality of high-capacity batteries, battery cells, or supercapacitors, which are capable of being recharged, for example, by plugging the vehicle into an electrical outlet, using regenerative braking, or using solar panels. The RESS provides a sustainable and efficient alternative to traditional internal combustion engines by reducing reliance on fossil fuels and lowering emissions. The RESS ensures that the vehicle has a reliable source of power, enabling longer driving ranges and improved performance while contributing to environmental conservation.

However, performing direct current (DC) fast charge (DCFC) of an RESS at high temperatures may lead to, for example, lithium plating or thermal runaway. Thus, the charging current is often derated at both cold and hot temps, but with a significant derating at hot temps to avoid thermal runaway. Existing RESS thermal management systems control coolant temperature to maintain RESS temperature within an optimal range to maximize the charge current. In existing solutions, the cooling power is conservatively limited to reduce battery degradation by avoiding condensation in the coolant loop. However, such deratings may negatively impact charging time and/or efficiency. Therefore, there is a need for adaptive thermal conditioning for RESSs that can decrease charging time and increase charging efficiency while avoiding condensation, lithium plating and/or thermal runaway. In disclosed implementations, ambient temperature and ambient relative humidity are used to determine the maximum allowable cooling power that can be used to cool the RESS without condensation. This maximizes the charging current, which results in faster charging times, especially in hot ambient conditions.

While configurations are shown and described herein in connection with an RESS for a vehicle (e.g., an automobile, a truck, an airplane, a helicopter, a train, a motorcycle, etc.), it should be understood that disclosed configurations may additionally, or alternatively, be used for providing adaptive thermal conditioning for an RESS used to power any other type of device or system.

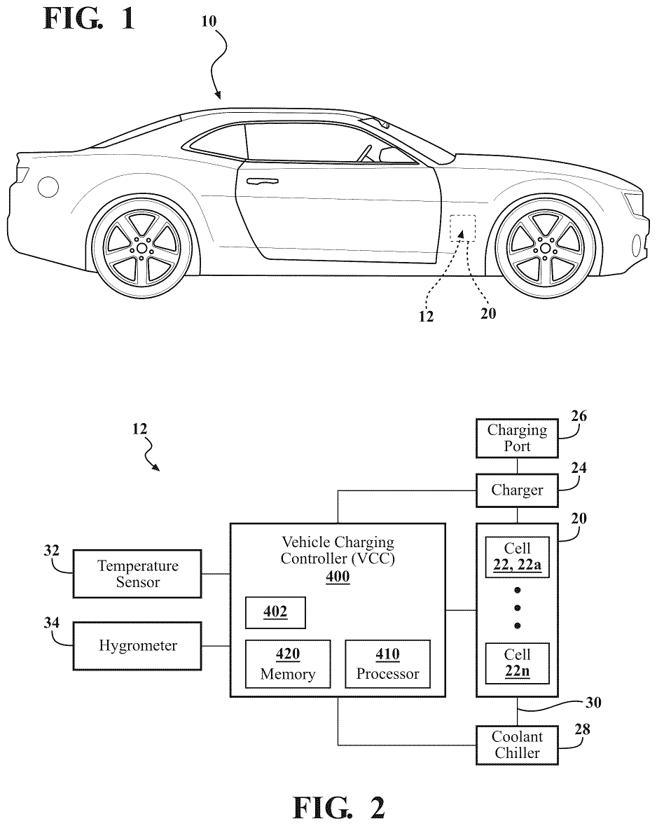

With particular reference to FIGS. 1 and 2, a vehicle 10 (e.g., an automobile, a truck, an airplane, a helicopter, a train, a motorcycle, etc.) is shown in conjunction with an RESS 12 for powering the vehicle 10. The vehicle 10 may be, for example, an electric vehicle (EV) or a hybrid electric vehicle (HEV). The RESS 12 includes a battery pack 20 having a plurality of battery cells 22, 22a-n. The battery pack 20 also includes a plurality of passageways defined between the battery cells 22 (not shown for clarity of illustrations). Here, the passageways of the plurality of passageways are configured to allow a coolant 30 to flow through the plurality of passageways to cool the plurality of battery cells 22 or, more generally, the battery pack 20 during, for example, charging of the battery pack 20.

The RESS 12 also includes a charger 24 configured to charge the battery pack 20 using electric power received via a charging port 26 when the charging port 26 is electrically connected to a power source (not shown for clarity of illustration), such as an electrical wall outlet or charging station.

The RESS 12 also includes a coolant chiller 28 configured to cool, chill or otherwise reduce the temperature of the coolant 30 that flows through the plurality of passageways of the battery pack 20 to cool the battery pack 20 during, but not limited to, charging of the battery pack 20 in warm ambient conditions. While not shown in FIG. 2 for clarity of illustration, the RESS 12 may also include a coolant heater for heating or otherwise increasing the temperature of the coolant 30 to warm the battery pack 20 during, but not limited to, use of or charging of the battery pack 20 in cold ambient conditions.

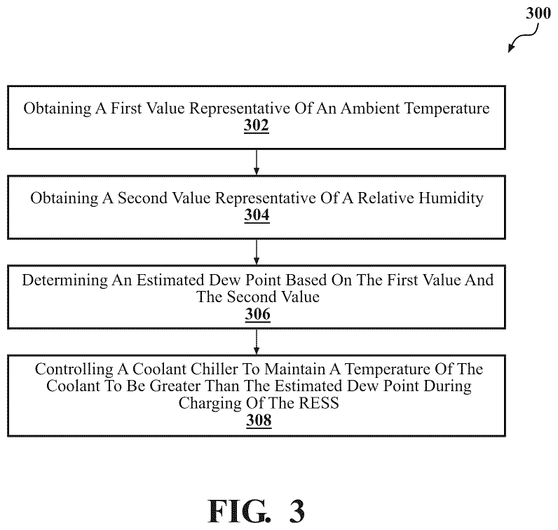

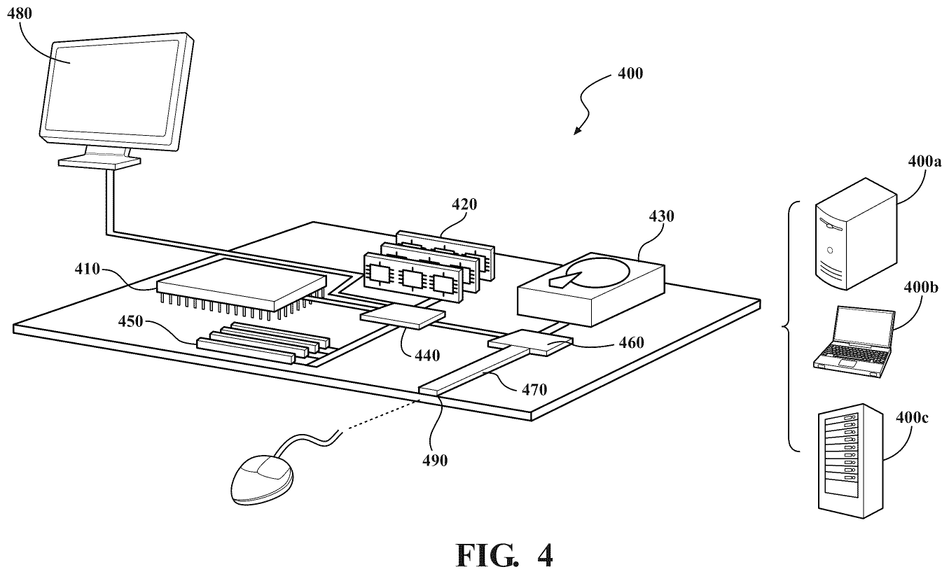

The RESS 12 also includes a vehicle charging controller (VCC) 400 (see FIG. 4) configured to perform operations for controlling the charger 24 for charging of the battery back 20. The VCC 400 also performs operations for controlling the coolant chiller 28 to provide adaptive thermal conditioning for the battery pack 20 while the battery pack 20 is being charged in warm ambient conditions. The VCC 400 stores machine-readable instructions on, for example, memory hardware 420. The instructions may be executed by data processing hardware 410 (e.g., a processor) of the VCC 400 to perform the operations of the VCC 400, such as the example operations of FIG. 3. In particular, the memory hardware 420 stores instructions that, when executed by the data processing hardware 410, cause the data processing hardware 410 to perform operations. The operations may include obtaining a first value representative of an ambient temperature T_{α} for the battery pack 20 or, more generally, for the vehicle 10, and obtaining a second value representative of a relative humidity RH for the battery pack 20 or, more generally, for the vehicle 10. The operations may also include determining an estimated dew point T_{DP} based on the first value and the second value, and controlling the coolant chiller 28 to maintain a temperature of the coolant 30 to be greater than a minimum temperature Tₘᵢₙ (e.g., the estimated dew point T_{DP}). The operations may further include controlling the charger 24 to control a rate of charging of the battery pack 20 based on the temperature of the coolant 30.

In some implementations, the VCC 400 uses a calibrated model 402 to determine, based on the first value and the second value, the estimated dew point T_{DP}. Here, parameters of the calibrated model 402 may be calibrated based on a psychometric chart representing physical and thermal properties of moist air. An example calibrated model 402 can be expressed as:

$${T}_{D P} ( {T}_{a} , RH ) = \frac{λ ( ln ( \frac{R H}{100} ) + \frac{β {T}_{a}}{λ + {T}_{a}} )}{β - ( ln ( \frac{R H}{100} ) + \frac{β {T}_{a}}{λ + {T}_{a}} )} , \qquad EQN ( 1 )$$

where T_{DP} is an estimated dew point, T_{α} is an ambient temperature, RH is an ambient relative humidity, and λ and β are parameters that are calibrated based on the psychometric chart representing physical and thermal properties of moist air. The VCC 400 determines the minimum temperature Tₘᵢₙ based on the estimated dew point T_{DP}. In some examples, the VCC 400 determines compensates the minimum temperature Tₘᵢₙ based on an uncertainty in relative humidity measurements.

In some examples, the vehicle 10 also includes a temperature sensor 32 configured to measure the first value representative of the ambient temperature T_{α}, and a hygrometer 34 configured to measure the second value representative of the relative humidity RH. In some implementations, the hygrometer 34 is on, or is a part of, a windshield of the vehicle 10. Additionally, or alternatively, the first value and the second value may be obtained from a weather service via, for example, a wireless fidelity (WiFi®) or satellite connection. Here, the first value may represent a measured ambient temperature or a forecasted ambient temperature, and the second value may represent a measured relative humidity or a forecasted relative humidity.

In some implementations, the VCC 400 adapts or changes the minimum temperature Tₘᵢₙ over time as ambient conditions change. That is, as the ambient temperature T_{α} and/or the relative humidity RH change over time. In particular, the operations may include obtaining a first plurality of values representative of respective ambient temperatures over time, obtaining a second plurality of values representative of respective relative humidities over time, determining, based on the first plurality of values and the second plurality of values, a plurality of estimated dew points, and adaptively controlling the coolant chiller 28 over time to maintain temperatures of the coolant 30 to be greater than the plurality of estimated dew points.

FIG. 3 is a flowchart of another exemplary arrangement of operations for a method 300 for adaptive thermal conditioning for the RESS 12. That is, for controlling chilling of the coolant 30 for cooling the RESS 12 during charging of the RESS 12 in warm ambient conditions. The operations may be performed by data processing hardware (e.g., the data processing hardware 410 of FIG. 4) based on executing instructions stored on memory hardware (e.g., the memory hardware 420 of FIG. 4). Many other ways of implementing the method 300 may be employed. For example, the order of execution of the operations may be changed, and/or one or more of the operations and/or interactions may be changed, eliminated, sub-divided, or combined. Additionally, the operations of FIG. 3 may be carried out sequentially and/or in parallel by, for example, separate processing threads, processors, devices, discrete logic, circuits, etc.

FIG. 4 is schematic view of an example computing device 400 that may be used to implement the systems and methods described herein. The computing device 400 is intended to represent various forms of digital computers, such as controllers, laptops, desktops, workstations, servers, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware), memory 420 (i.e., memory hardware), a storage device 430 (i.e., memory hardware), a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high-speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack comprising a plurality of battery cells and a plurality of passageways defined between the battery cells, wherein passageways of the plurality of passageways are configured to allow a coolant to flow through the plurality of passageways to cool the plurality of battery cells;
a coolant chiller configured to chill the coolant for cooling the plurality of battery cells during charging of the battery pack;
data processing hardware; and
memory hardware in communication with the data processing hardware and storing instructions that, when executed by the data processing hardware, cause the data processing hardware to perform operations comprising:
obtaining a first value representative of an ambient temperature;
obtaining a second value representative of a relative humidity;
determining an estimated dew point based on the first value and the second value; and
controlling the coolant chiller to maintain a temperature of the coolant to be greater than the estimated dew point.

2. The vehicle of claim 1, wherein the operations further comprise controlling a rate of charging of the battery pack based on the temperature of the coolant.

3. The vehicle of claim 1, wherein the vehicle further comprises:
a temperature sensor configured to measure the first value representative of the ambient temperature; and
a hygrometer configured to measure the second value representative of the relative humidity.

4. The vehicle of claim 3, wherein the vehicle further comprises a windshield comprising the hygrometer.

5. The vehicle of claim 1, wherein:
the first value represents at least one of a measured ambient temperature or a forecasted ambient temperature;
obtaining the first value representative of the ambient temperature comprises obtaining the first value from a weather service;
the second value represents at least one of a measured relative humidity or a forecasted relative humidity; and
obtaining the second value representative of the relative humidity comprises obtaining the second value from the weather service.

6. The vehicle of claim 1, wherein the operations further comprise:
obtaining a first plurality of values representative of respective ambient temperatures over time;
obtaining a second plurality of values representative of respective relative humidities over time;
determining, based on the first plurality of values and the second plurality of values, a plurality of estimated dew points; and
controlling the coolant chiller over time to maintain temperatures of the coolant to be greater the plurality of estimated dew points.

7. The vehicle of claim 1, wherein determining the estimated dew point comprises using a calibrated model to determine, based on the first value and the second value, the estimated dew point, wherein parameters of the calibrated model are calibrated based on a psychometric chart representing physical and thermal properties of moist air.

8. The vehicle of claim 7, determining the estimated dew point further comprise compensating for an uncertainty in the second value.

9. A method for controlling chilling of a coolant for cooling a rechargeable energy storage system (RESS) during charging of the RESS, the method comprising:
obtaining a first value representative of an ambient temperature;
obtaining a second value representative of a relative humidity;
determining an estimated dew point based on the first value and the second value; and
controlling a coolant chiller to maintain a temperature of the coolant to be greater than the estimated dew point during charging of the RESS.

10. The method of claim 9, further comprising controlling a rate of charging of the RESS based on the temperature of the coolant.

11. The method of claim 9, wherein:
obtaining the first value comprises obtaining the first value from a temperature sensor associated with the RESS; and
obtaining the second value comprises obtaining the second value from a hygrometer associated with the RESS.

12. The method of claim 9, wherein:
the first value represents at least one of a measured ambient temperature or a forecasted ambient temperature;
obtaining the first value representative of the ambient temperature comprises obtaining the first value from a weather service;
the second value represents at least one of a measured relative humidity or a forecasted relative humidity; and
obtaining the second value representative of the relative humidity comprises obtaining the second value from the weather service.

13. The method of claim 9, wherein determining the estimated dew point comprises using a calibrated model to determine, based on the first value and the second value, the estimated dew point, wherein parameters of the calibrated model are calibrated based on a psychometric chart representing physical and thermal properties of moist air.

14. The method of claim 13, determining the estimated dew point further comprises compensating for an uncertainty in the second value.

15. A system for controlling chilling of a coolant for cooling a rechargeable energy storage system (RESS) during charging of the RESS, the system comprising:
data processing hardware; and
memory hardware in communication with the data processing hardware and storing instructions that, when executed by the data processing hardware, cause the data processing hardware to perform operations comprising:
obtaining a first value representative of an ambient temperature;
obtaining a second value representative of a relative humidity;
determining an estimated dew point based on the first value and the second value; and
controlling a coolant chiller to maintain a temperature of the coolant to be greater than the estimated dew point during charging of the RESS.

16. The system of claim 15, wherein the operations further comprise controlling a rate of charging of the RESS based on the temperature of the coolant.

17. The system of claim 15, wherein:
obtaining the first value comprises obtaining the first value from a temperature sensor associated with the RESS; and
obtaining the second value comprises obtaining the second value from a hygrometer associated with the RESS.

18. The system of claim 15, wherein:
the first value represents at least one of a measured ambient temperature or a forecasted ambient temperature;
obtaining the first value representative of the ambient temperature comprises obtaining the first value from a weather service;
the second value represents at least one of a measured relative humidity or a forecasted relative humidity; and
obtaining the second value representative of the relative humidity comprises obtaining the second value from the weather service.

19. The system of claim 15, wherein determining the estimated dew point comprises using a calibrated model to determine, based on the first value and the second value, the estimated dew point, wherein parameters of the calibrated model are calibrated based on a psychometric chart representing physical and thermal properties of moist air.

20. The system of claim 19, determining the estimated dew point further comprise compensating for an uncertainty in the second value.
